(19) United States
(12) Patent Application Publication
(10) Pub. No.: US 2008/0158340 A1
(43) Pub. Date: Jul. 3, 2008

(54) VIDEO CHAT APPARATUS AND METHOD

(75) Inventors: Tomoyuki Shibata, Kanagawa (JP); Osamu Yamaguchi, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/950,188

(22) Filed: Dec. 4, 2007

(30) Foreign Application Priority Data
Dec. 4, 2006 (JP) 2006-327468

(51) Int. Cl. H04N 7/14

(52) U.S. Cl. 348/14.16; 348/E07.077

(57) ABSTRACT

A video chat apparatus includes an image pickup unit having two cameras, a three-dimensional information acquiring unit, a window position acquiring unit, a rotational amount determining unit, an image generating unit, an image output unit, and a parameter storage unit. Eye-gaze correction is achieved only by changing the position of viewpoint of virtual cameras by the position of a window on the display and gazing at the other party of the chat.

### CROSS-REFERENCE TO RELATED APPLICATIONS

This application is based upon and claims the benefit of priority from the prior Japanese Patent Application No. 2006-327468, filed on Dec. 4, 2006; the entire contents of which are incorporated herein by reference.

### BACKGROUND OF THE INVENTION

1. Field of the Invention

The present invention relates to video chat apparatus and method for teleconferences or the like, in which a virtual viewpoint is changed depending on the position of a window on which the other party of a chat is displayed, so that eye-gaze correction is achieved.

2. Description of the Related Art

In a system in the related art which is disclosed in JP Application kokai 2006-114023 and a non patent document, “Video-Teleconferencing System with Eye-gaze correction (U.S. Pat. No. 6,771,303 (Aug. 3, 2004) Zhengyou Zhang Microsoft Corporation)”, the position of the viewpoint of a virtual camera is set to the center of a display and an image is generated on the display. Therefore, when a window on which the other party of the video chat is not displayed at the center of the display, eye-gaze correction, which is the intended purpose, is not achieved. Since the position of the viewpoint of the virtual camera is limited to the center of the display, when an image from a given virtual viewpoint is generated using three-dimensional position of a scene, the image having a partly lost background is obtained, which gives a viewer a sense of discomfort.

In a case in which a half mirror, which is disclosed in JP Application kokai 9-107534, is used, the scale of the apparatus increases, and the same number of cameras as the windows are required. Therefore, it is not easy to put it into a practical use.

As described above, the related art has a problem such that the position of the viewpoint of the virtual camera is fixed to the center of the display, and hence when the position of the window is not at the center of the display, the eye-gaze correction, which is the intended purpose, is not achieved.

The image from a virtual viewpoint is generated by obtaining three-dimensional position of a scene from the image. Therefore, when the image from a given viewpoint is generated, mutual occlusion occurs. The mutual occlusion is a phenomenon that a part of the three-dimensional position cannot be obtained because a foreground substance hides a background due to the difference in depth, and is one of the occlusion problems. Accordingly, there is a problem such that there exists an area in which the image cannot be expressed because of absence of the three-dimensional position depending on the position of the viewpoint.

### BRIEF SUMMARY OF THE INVENTION

Accordingly, it is an object of the invention to provide video chat apparatus and method which achieve natural eye-gaze correction.

According to embodiments of the invention, there is provided a video chat apparatus including: a display; a receiving unit configured to receive external images from other party having a chat with a user; an external image displaying unit configured to set a window on the display and display the external image in the window; a plurality of cameras having a common field of view, which pick up a plurality of face images of a user; an image rectification unit configured to select a first image and a second image from the plurality of face images picked up by the respective cameras and obtain a parallelized first image and a parallelized second image by rectifying the first image and the second image so that epipolar lines of the first image and the second image are parallelized; a three-dimensional information acquiring unit configured to acquire three-dimensional position of respective pixels in the parallelized first image on the basis of a correspondence relation indicating pixels in the parallelized second image to which the respective pixels in the parallelized first image correspond; a window position acquiring unit configured to detect a window display position in a display area on the display; a rotational amount determining unit configured to rotate the three-dimensional position at the respective pixels on the basis of the window display position and determining the amount of rotation for viewpoint conversion for obtaining a virtual viewpoint image picked up from a virtual viewpoint which corresponds to the center of the window display position; an image generating unit configured to generate the virtual viewpoint image from the three-dimensional position of the respective pixels and the amount of rotation; and an image output unit configured to output the virtual viewpoint image.

According to embodiments of the invention, since the positions of the viewpoints of the virtual cameras are changed according to the positions of the windows on the display, the eye-gaze correction is achieved only by gazing at the other party of the chat, and hence further realistic video chat is achieved.

### BRIEF DESCRIPTION OF THE DRAWINGS

FIG. 1 is a block diagram showing a configuration of a video chat apparatus according to a first embodiment of the invention;

FIG. 2 is a flowchart showing an operation in the first embodiment;

FIG. 3 is a block diagram showing a configuration of the video chat apparatus according to a second embodiment of the invention;

FIG. 4 is a flowchart showing to an operation in the second embodiment;

FIG. 5 is an explanatory drawing showing a teleconference held by four persons according to the first embodiment;

FIG. 6 is an explanatory drawing of the related art and the first embodiment; and

FIG. 7 is an explanatory drawing of the related art and the second embodiment.

### DETAILED DESCRIPTION OF THE INVENTION

Referring now to the drawings, embodiments of the invention will be described.

### First Embodiment

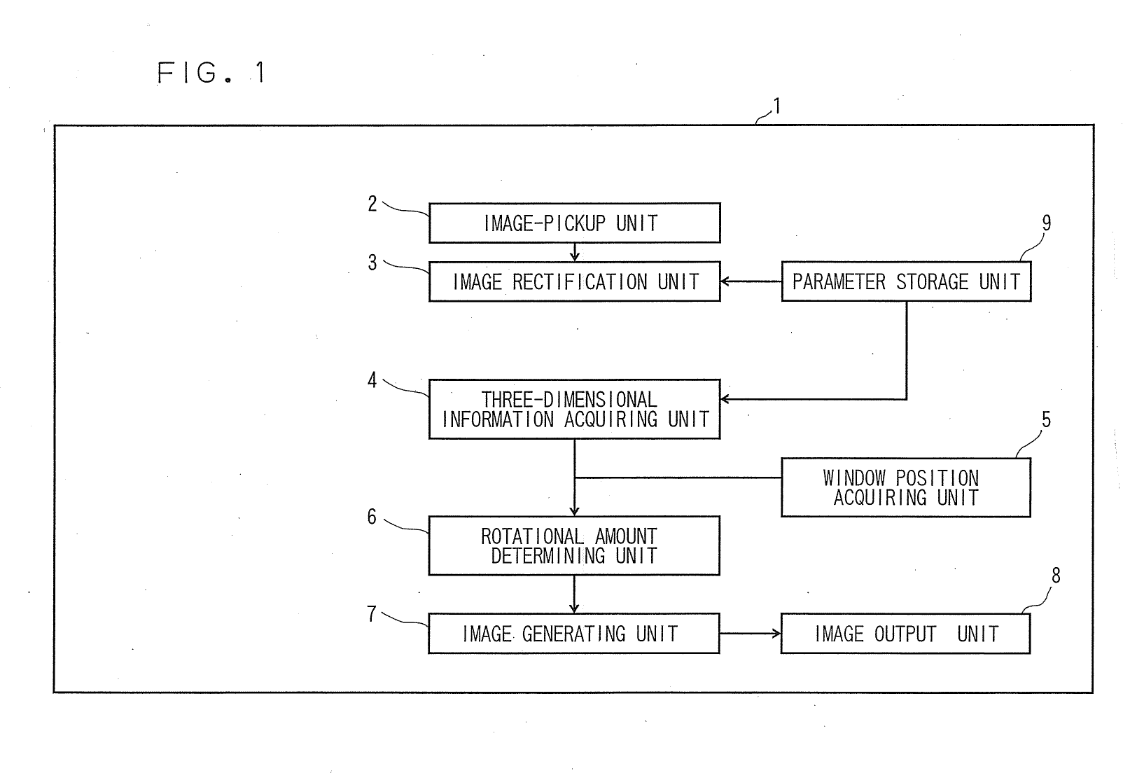

Referring now to FIGS. 1, 2, 5 and 6, a video chat apparatus 1 according to a first embodiment of the invention will be described.

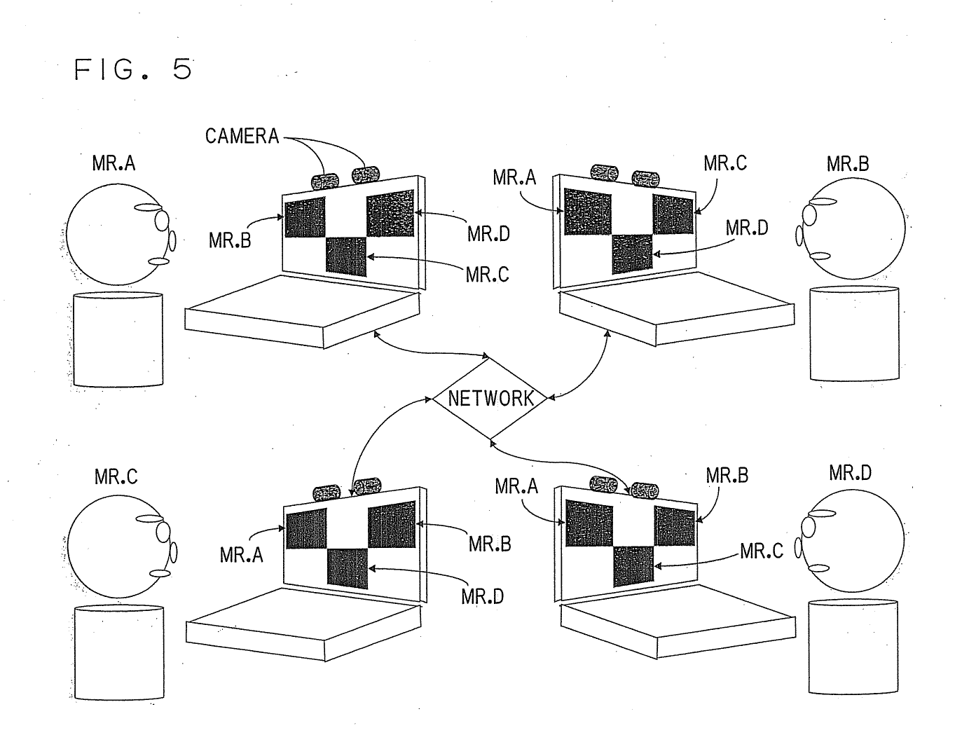

As shown in FIG. 5, when four persons, A, B, C and D at different locations have a teleconference, each person has equipment including a laptop personal computer and two cameras attached to the laptop personal computer. It is assumed that three persons other than the owner of the laptop personal computer are displayed in three windows on a display of each laptop personal computer. The image of the face of each person is taken by the two cameras, and video signals taken by these cameras and voice signals taken by a microphone are transmitted through networks such as a LAN or internet.

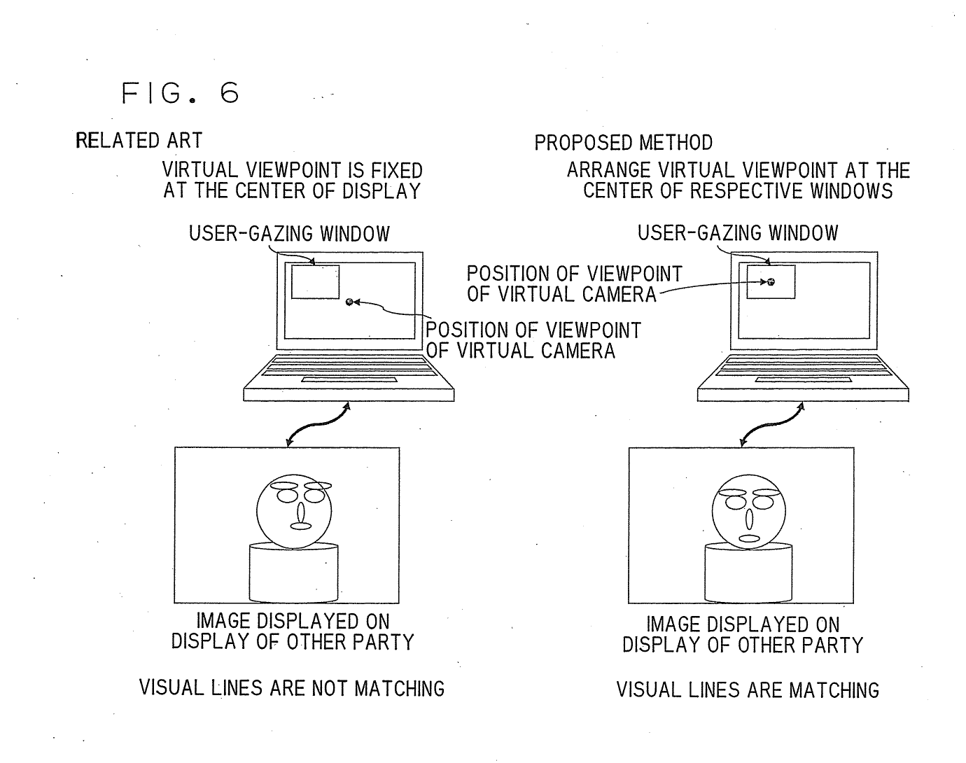

In the related art, as shown in the drawing on the upper left side in FIG. 6, in the case of the laptop personal computer owned by Mr. A, for example, when Mr. A has a chat with Mr. B displayed on the upper left portion of the display (a user-gaze window in the drawing), Mr. A talks while watching the upper left portion of the display, but not the center of the display (the position of a virtual viewpoint of the virtual camera). Therefore, the face of Mr. A in an image displayed on the display of Mr. B's laptop personal computer is faced toward the upper left as shown in the drawing on the lower left side in FIG. 6, and hence Mr. A and Mr. B cannot look at each other.

Therefore, in this embodiment, the video chat apparatus 1 is integrated in the laptop personal computer of each person to bring the visual lines of Mr. A and Mr. B to match with respect to each other. In other words, as shown in the drawing on the upper right side in FIG. 6, the position of the viewpoint of the virtual camera is fixed to the upper left of the display (the center of the user-gaze window in the drawing) of the Mr. A's laptop personal computer. Therefore, when the Mr. A has a chat with Mr. B while looking at the Mr. B displayed on the upper left, the face of Mr. A in the image displayed on the display of the Mr. B's laptop personal computer is converted into a state faced toward the front as shown in the drawing on the lower right side in FIG. 6 to achieve the eye-gaze correction with Mr. B.

The video chat apparatus 1 will be described below.

(1) Configuration of Video chat apparatus 1

FIG. 1 is a block diagram showing the video chat apparatus 1 in this embodiment.

The video chat apparatus 1 includes an image-pickup unit 2, an image rectification unit 3, a three-dimensional information acquiring unit 4, a window position acquiring unit 5, a rotational amount determining unit 6, an image generating unit 7, an image output unit 8 and a parameter storage unit 9.

The respective functions of the respective units 2 to 9 described below are also achieved by a program stored in the computer.

In order to facilitate description, the description is focused on the video chat apparatus 1 integrated in Mr. A's laptop personal computer in FIG. 5. However, the video chat apparatus 1 is also integrated in the laptop personal computers of other three persons in the same manner.

### (1-1) Image-Pickup Unit 2

The image-pickup unit 2 includes at least two or more cameras, and takes a scene (a scene including the face of Mr. A) by the respective cameras, stores the same as an image, and sends it to the image rectification unit 3.

### (1-2) Parameter Storage Unit 9

The parameter storage unit 9 stores internal parameters of the respective cameras to be installed and external parameters of the respective cameras, and sends the parameters to the image rectification unit 3 and the three-dimensional information acquiring unit 4.

(1-3) Image rectification unit 3

The image rectification unit 3 determines one of the input images from the image-pickup unit 2 as a base image, and other images as reference images, and performs rectification so that epipolar lines of the basic image and the respective reference images are parallelized based on the internal parameters and the external parameters stored in the parameter storage unit 9 of the respective cameras. The images after parallelization, which are parallelized images, are sent to the three-dimensional information acquiring unit 4 as the input images.

In the case of rectification, the rectification is performed on the basic image and all the reference images so that the epipolar lines of the basic image and the respective reference images are parallelized.

It is also possible to perform the rectification only for the reference images so that the epipolar lines of the reference images are parallelized with the basic image without performing the rectification of the basic image.

### (1-4) Three-Dimensional Information Acquiring Unit 4

The three-dimensional information acquiring unit 4 performs corresponding point search on the basic image and the reference images from among the parallelized images from the image rectification unit 3 to find pixels in the basic image to which respective pixels in the reference images correspond, and obtains parallax images having brightness values which correspond to the numbers of pixels to the corresponding points respectively.

The three-dimensional information acquiring unit 4 acquires the three-dimensional position at the each pixel in the basic image under the principle of triangulation from the external parameters and the internal parameters of the respective cameras from the parameter storage unit 9 and the parallax images, and sends the acquired three-dimensional position to the image generating unit 7.

### (1-5) Window Position Acquiring Unit 5

The window position acquiring unit 5 acquires the positions of the windows on the display in which the other parties of the chat (Mr. B, Mr. C, Mr. D) are displayed respectively, and sends the positions of the windows to the rotational amount determining unit 6. In other words, since the three windows are provided for displaying three persons on the display of Mr. A's laptop personal computer, the window position acquiring unit 5 sends the positions of the windows of Mr. B, Mr. C and Mr. D to the rotational amount determining unit 6.

(1-6) Rotational amount determining unit 6

Viewpoint conversion is performs by rotating the three-dimensional position from the positions of the respective windows sent from the window position acquiring unit 5. The rotational amount determining unit 6 determines the amounts of rotation for this conversion respectively. The amounts of rotation are obtained by inspecting the rotational amounts for performing the viewpoint conversion from four corners to the virtual viewpoints located at the centers of the respective windows on the display of the Mr. A's laptop personal computer in advance and performing linear interpolation. The obtained amounts of rotation are sent to the image generating unit 7.

### (1-7) Image Generating Unit 7

The image generating unit 7 performs the viewpoint conversion respectively by rotating the acquired three-dimensional position in a world coordinate system on the basis of the three-dimensional position from the three-dimensional information acquiring unit 4 and the amounts of rotation from the rotational amount determining unit 6. The center of rotation is set to an intersection between the normal line from the center of the display with respect to a display plane and the optical axis of the reference camera.

Subsequently, respective virtual viewpoint images picked up from the virtual viewpoints are acquired, and the respective virtual viewpoint images are sent to the image output unit 8. For example, Mr. A in the virtual viewpoint images faces the front from the virtual viewpoint through the window of Mr. B.

### (1-8) Image Output Unit 8

The image output unit 8 outputs the virtual viewpoint images sent from the image generating unit 7 to the displays of the laptop personal computers of the other parties of the chat respectively.

For example, the virtual viewpoint image of the face of Mr. A facing the front is displayed on the display of the Mr. B's laptop personal computer.

The virtual viewpoint image of the face of Mr. A facing the upper left, which is viewed from the virtual viewpoint of the window directly below, is displayed on the display of the Mr. C's laptop personal computer.

The virtual viewpoint image of the face of Mr. A facing the upper left, which is viewed from the virtual viewpoint of the upper right window, is displayed on the display of the Mr. D's laptop personal computer.

### (2) Procedure of Outputting Virtual Viewpoint Image

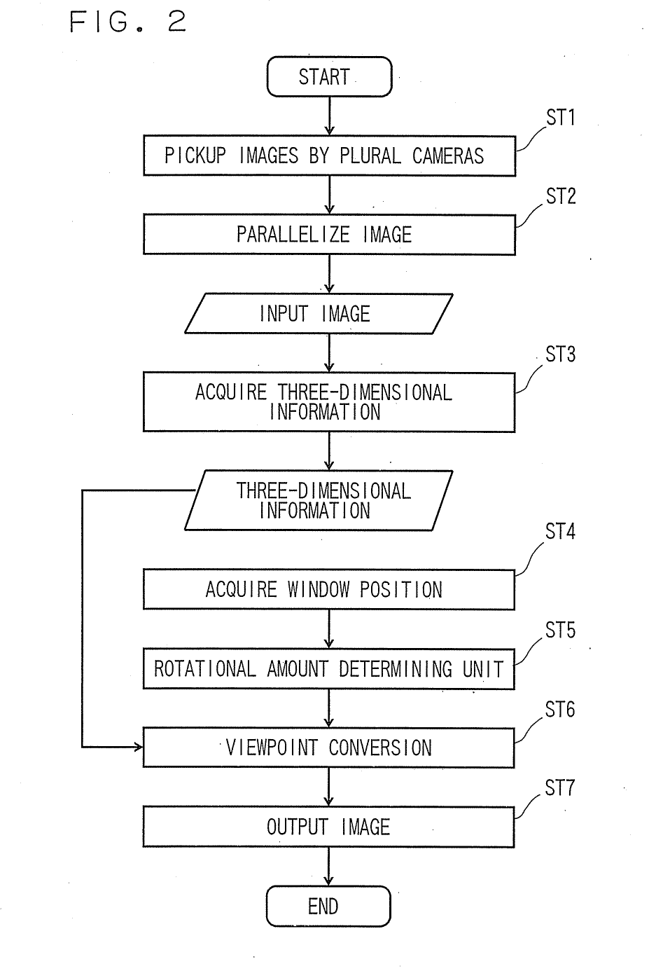

FIG. 2 is a flowchart showing an example of the procedure for outputting the virtual viewpoint image according to the embodiment. The procedure will be as shown below. A case in which a teleconference is performed on Mr. A's laptop personal computer with Mr. B, Mr. C and Mr. D as shown in FIG. 5 is assumed.

Firstly, in Step 1, the images of the face of Mr. A picked up by the two cameras on the Mr. A's laptop personal computer are stored, and the procedure goes to Step °.

Subsequently, in Step 2, one of the images received in Step 1 is determined as a basic input image, and others are determined as reference input images, and rectification is performed so that the epipolar lines of the basic input image and the respective reference input images are parallelized based on the internal parameters and the external parameters of the respective cameras. The image after rectification is determined as the input images, and the procedure goes to Step 3.

In Step 3, corresponding point search is performed on the basic input image and the reference input images from among the input images received in Step 2 for searching the pixels in the reference input images which correspond to the respective pixels in the basic input image, and the parallax image givens by the number of pixels to the corresponding points as brightness value is obtained. Then, the three-dimensional position of the scene is acquired under the principle of triangulation from the respective parallax images, the external parameters and the internal parameters of the respective cameras, and the procedure goes to Step 6.

In Step 4, the positions of the windows of the other parties of the chat on the display of Mr. A's laptop personal computer (windows at upper left for Mr. B, directly below for Mr. C, and upper right for Mr. D) are acquired, and the procedure goes to Step 5.

In Step 5, the amounts of rotation of the three-dimensional position for performing the viewpoint conversion are obtained from the respective positions of the windows received in Step 4, and the procedure goes to Step 6.

In Step 6, the viewpoint conversion is performed on the basis of the three-dimensional position received in Step 3 and the respective amounts of rotation received in Step 5, and the virtual viewpoint images for Mr. B, Mr. C and Mr. D are restructured. Then, the procedure goes to Step 7.

In Step 7, the respective virtual viewpoint images received in Step 6 are sent to Mr. B, Mr. C and Mr. D correspondingly, and are displayed on the displays of the laptop personal computers of individuals respectively.

### (3) Advantages

According to the first embodiment, since the positions of the viewpoints of the virtual cameras are changed according to the positions of the windows, eye-gaze correction is achieved only by gazing at the other party of the chat, and hence further realistic video chat is achieved.

In contrast to the related art, the center of rotation for the viewpoint conversion is set to the center of the depth value of the foreground substance, the foreground substance after the viewpoint conversion is displayed at the same position without being deviated from the image coordinate. Therefore, the process to convert the display position such as parallel translation is not necessary.

### Second Embodiment

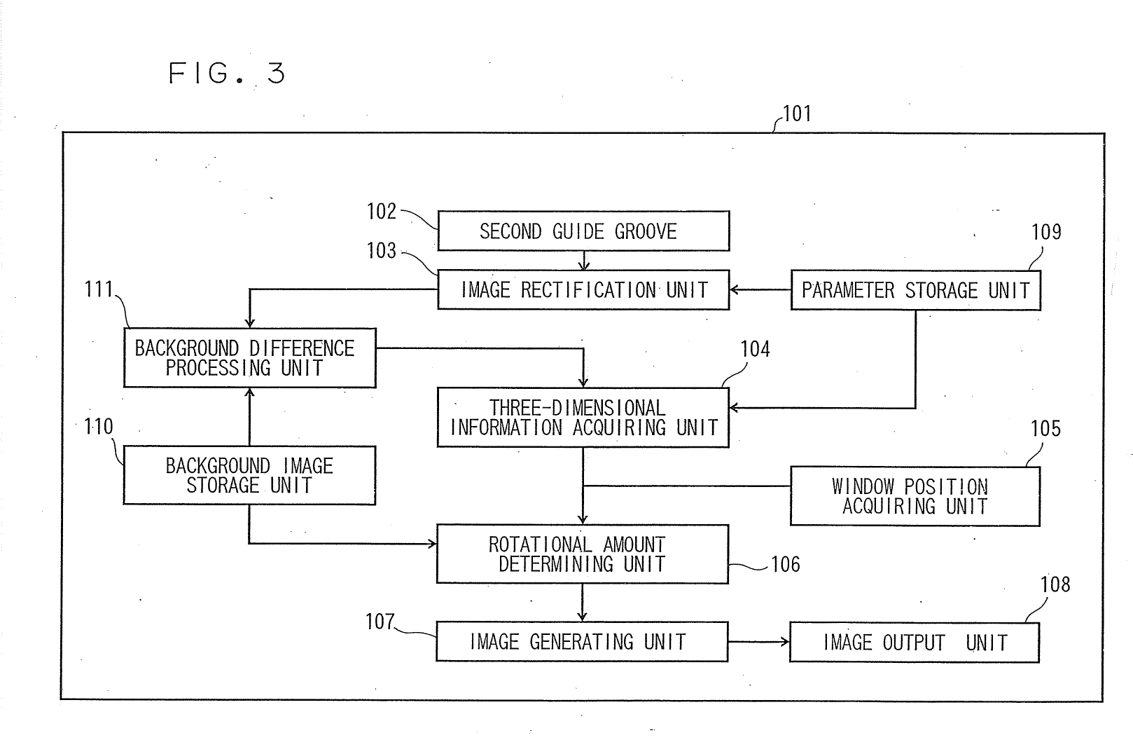

Referring now to FIGS. 3, 4 and 7, a video chat apparatus 101 according to a second embodiment of the invention will be described.

In the video chat apparatus 101, only areas of foreground substances as subjects are detected from input images in a background difference processing unit 111 using background images recorded in a background image storage unit 110, and the three-dimensional position of the subject is acquired by a three-dimensional information acquiring unit 104. An image generating unit 107 restructures the images of the areas of the foreground substances from the virtual viewpoints and layers the same on the background images stored in the background image storage unit 110 to generate virtual viewpoint images, and sends the same to an image output unit 108.

(1) Configuration of Video chat apparatus 101

FIG. 3 is a block diagram showing the video chat apparatus 101 according to the second embodiment.

The video chat apparatus 101 includes an image-pickup unit 2, an image rectification unit 103, the three-dimensional information acquiring unit 104, a window position acquiring unit 105, a rotational amount determining unit 106, the image generating unit 107, the image output unit 108, a parameter storage unit 109, the background image storage unit 110 and the background difference processing unit 111.

In the operation of the video chat apparatus 101, the same configurations and processing as in the case of the video chat apparatus 1 in the first embodiment will be omitted.

### (1-1) Background Image Storage Unit 110

The background image storage unit 110 stores images or video images picked up in advance by eliminating the subjects whose three-dimensional position are desired from the images parallelized by the image rectification unit 103 (hereinafter, referred to as “background images”) in the interior of the device, and sends the same to the image generating unit 107 and the background difference processing unit 111.

In other words, images of the background only are picked up with the respective cameras, then, the respective background images are applied with the rectification and parallelized so that the epipolar lines are parallelized, and then the parallelized background images are stored.

### (1-2) Background Difference Processing Unit 111

The background difference processing unit 111 obtains the differences between the parallelized basic image from the image rectification unit 103 and the parallelized background images picked up by the cameras corresponding to the basic image. The background difference processing unit 111 also obtains differences between the parallelized reference images sent from the image rectification unit 103 and the parallelized background images picked up by the corresponding cameras. Then, areas in the parallelized basic image and the parallelized reference images different from the parallelized background images are detected, and images of the areas of foreground substances which correspond to the detected areas are generated and are sent to the three-dimensional information acquiring unit 104.

### (1-3) Image Generating Unit 107

The image generating unit 107 performs the viewpoint conversion by rotating the acquired three-dimensional position in the world coordinate system on the basis of the three-dimensional position from the three-dimensional information acquiring unit 104, the amounts of rotation from the rotational amount determining unit 106 and the background images from the background image storage unit 110, and restructures the virtual viewpoint images only of the areas of the foreground substances. The center of rotation is set to intersection between the normal line from the center of the display with respect to the display plane and the optical axis of the reference camera.

Subsequently, virtual viewpoint images only of the areas of the foreground substances picked up from the virtual viewpoints are acquired, and the images of the areas of the foreground substances are layered on the background images to generate general virtual viewpoint images, which are sent to the image output unit 108.

### (2) Procedure of Outputting Virtual Viewpoint Image

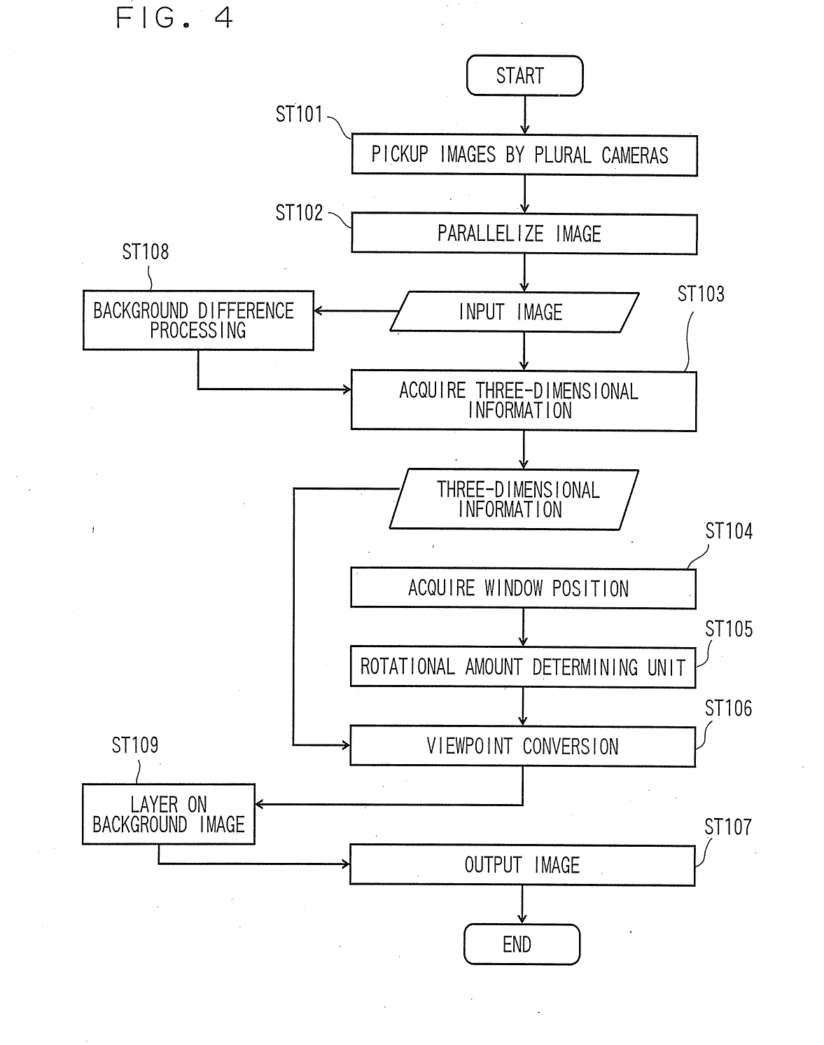

FIG. 4 is a flowchart showing an example of the procedure of outputting the virtual viewpoint images according to the second embodiment. The procedure will be as shown below. Description of the same procedure as in the procedure of outputting the virtual viewpoint image described in conjunction with FIG. 2 will be omitted.

In Step 108, the background difference processing is performed using the input images received in Step 102 and the background images stored in the background image storage unit 110, and the areas of the foreground substances which are different from the background areas in the input images are detected. Then, the procedure goes to Step 103.

In step 109, the respective virtual viewpoint images of the areas of the foreground substances received in Step 106 are respectively layered on the background images stored in the background image storage unit 110 to generate virtual viewpoint images. Then, the procedure goes to Step 107.

### (3) Advantages

Advantages obtained by introducing the background difference processing will be described below.

The basic problem of the stereovision in the related art to be solved is a problem of corresponding points for coordinating a point in the three-dimensional space with points projected on two images correctly. As a matter of course, unless the corresponding points are obtained with high degree of accuracy, accurate three-dimensional position of a scene cannot be acquired and there arises contradiction between the actual scene and the image when the image is restructured from given virtual viewpoint.

As a major reason of failing the corresponding point search is a problem of occlusion. The problem of occlusion, being caused by the difference in viewpoint between cameras, is that there are points that are observed from one of the cameras, but are not observed from the other camera, so that the real corresponding points cannot be obtained. The occlusion roughly includes a mutual occlusion such that the foreground substance from the one camera hides the background due to the difference in depth between the foreground substance and the background and a self occlusion such that a plane of the foreground substance which is observed by the one camera is not observed by the other camera. Robust methods of searching corresponding points focusing on the occlusion are proposed. However, there is no method which can solve the problem completely, and hence the real-time processing is difficult in many of these proposed methods.

Therefore, the mutual occlusion which is one of the problems of occlusion is solved by the background difference processing. By separating the background and the foreground substance, the mutual occlusion is eliminated. Consequently, the possibility of erroneous correspondence is reduced, and hence the accuracy of corresponding point search is improved. In addition, since the search range is limited, the speed-up of search is achieved.

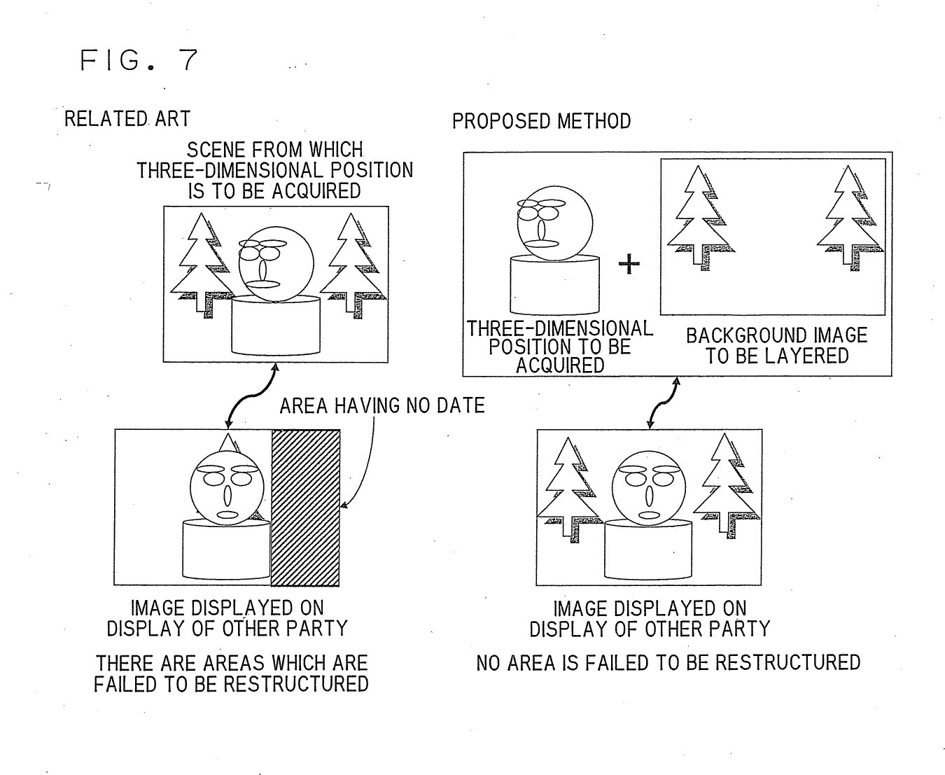

As shown in the drawing on the left side in FIG. 7, when an attempt is made to convert the viewpoint of the virtual camera arbitrary on the basis of the acquired three-dimensional position and restructure an image from an ideal viewpoint of the camera which is to be obtained, the viewpoint conversion is performed by rotating the three-dimensional position in the world coordinate system. However, when the three-dimensional position for all the scenes are obtained, it is necessary to change the center of rotation from scene to scene, and the generated image has lots of areas which are failed to be restructured.

Therefore, in the second embodiment, as shown in the drawing on the right side, in the case of the three-dimensional position only of the areas of foreground substances, an average of the depth values of the obtained areas of foreground substances is determined as the center of rotation, the three-dimensional information is rotated to convert the viewpoint, and the converted image is layered on the background image to generate an image. In this procedure, there is no area failed to be restructured in the generated image, and the center of rotation is uniquely defined.

### Modification

The invention is not limited to the above described embodiment, and may be modified in various manners without departing from the scope of the invention.

### (1) Modification 1

In the embodiments shown above, the center of rotation is determined to be the intersection between the normal line from the center of the display with respect to the display plane and the optical axis of the reference camera. However, an average of the depth values of the obtained three-dimensional position may be determined as the center of rotation.

### (2) Modification 2

In the embodiments shown above, the center of rotation is determined to be the intersection between the normal line from the center of the display with respect to the display plane and the optical axis of the reference camera. However, it is also possible to add a face detection unit and determine the center of rotation according to the obtained position of the face area.

For example, the center of rotation may be determined in such a manner that the face area always comes to the center of the image after the viewpoint conversion. Alternatively, the center of rotation may be determined in such a manner that the sized of the face area is fixed.

### (3) Modification 3

In the embodiments shown above, the amount of rotation is determined uniquely by the rotational amount determining unit. However, it is also possible to control the amount of rotation on the basis of a value obtained from the outside, and generate the image form the given virtual viewpoint later.

What is claimed is:

1. A video chat apparatus comprising:
a display;
a receiving unit configured to receive external images from other party having a chat with a user;
an external image displaying unit configured to set a window on the display and display the external image in the window;
a plurality of cameras having a common field of view, which pick up a plurality of face images of a user;
an image rectification unit configured to select a first image and a second image from the plurality of face images picked up by the respective cameras and obtain a parallelized first image and a parallelized second image by rectifying the first image and the second image so that epipolar lines of the first image and the second image are parallelized;
a three-dimensional information acquiring unit configured to acquire three-dimensional position of respective pixels in the parallelized first image on the basis of a correspondence relation indicating pixels in the parallelized second image to which the respective pixels in the parallelized first image correspond;
a window position acquiring unit configured to detect window display position in a display area on the display;
a rotational amount determining unit configured to rotate the three-dimensional position at the respective pixels on the basis of the window display position and determining the amount of rotation for viewpoint conversion for obtaining a virtual viewpoint image picked up from a virtual viewpoint which corresponds to the center of the window display position;
an image generating unit configured to generate the virtual viewpoint image from the three-dimensional position of the respective pixels and the amount of rotation; and
an image output unit configured to output the virtual viewpoint image.

2. The apparatus according to claim 1, further comprising:
a background image storage unit configured to store a background image; and
a background difference processing unit configured to obtain the difference between the parallelized first image and the background image, and the difference between the parallelized second image and the background image respectively and detecting only the areas of foreground substances in the parallelized first images and the background image respectively,
wherein the three-dimensional information acquiring unit acquires three-dimensional position only of the areas of the foreground substances on the basis of the correspondence relation between the area of the foreground substance in the parallelized first image and the area of the foreground substance in the parallelized second image, and
wherein the image generating unit generates the virtual viewpoint image including only the area of foreground substance, and layers the background image on the generated virtual viewpoint image.

3. The apparatus according to claim 1, wherein the image generating unit generates the virtual viewpoint image by rotating the three-dimensional position about an intersection between the normal line from the center of the display with respect to the display plane and the optical axis of the one reference camera from among the plurality of cameras.

4. The apparatus according to claim 1, wherein the image generating unit rotates the three-dimensional position about an average of depth values of the three-dimensional position as a center of rotation to generate the virtual viewpoint image.

5. The apparatus according to claim 1, further comprising a face detection unit configured to detect the face of his/her own,
wherein the image generating unit sets the position of the center of rotation of the three-dimensional position according to the position of the face acquired by the face detection.

6. The apparatus according to claim 1, wherein the rotational amount determining unit receives input of the amount of rotation of the three-dimensional position from the outside.

7. The apparatus according to claim 1, wherein the image rectification unit obtains the parallelized second image by performing rectification so that the epipolar line of the second image is parallelized with the epipolar line of the first image, and outputs the first image as the parallelized first image.

8. A method of having chat by a video chat apparatus including a display and a plurality of cameras having a common field of view, which pick up a plurality of face images of a user comprising:
receiving an external image from other party having a chat with the user;
setting a window on the display and displaying the external image in the window;
selecting a first image and a second image from the plurality of face images picked up by the respective cameras and obtaining a parallelized first image and a parallelized second image by rectifying the first image and the second image so that epipolar lines of the first image and the second image are parallelized;
acquiring three-dimensional position of respective pixels in the parallelized first image on the basis of a correspondence relation indicating pixels in the parallelized second image to which the respective pixels in the parallelized first image correspond;
detecting the position to display the window in a display area on the display;
rotating the three-dimensional position at the respective pixels on the basis of the position of display of the window and determining the amount of rotation for viewpoint conversion for obtaining a virtual viewpoint image picked up from a virtual viewpoint which is the center of the window to be displayed;
generating the virtual viewpoint image from the three-dimensional position of the respective pixels and the amount of rotation; and
outputting the virtual viewpoint image.

9. A program stored in a computer readable medium for causing a computer to function a video chat apparatus including a display and a plurality of cameras having a common field of view, which pick up a plurality of face images of a user, the program comprising functions of:
receiving an external image from other party having a chat with the user;
setting a window on the display and displaying the external image in the window;
selecting a first image and a second image from the plurality of face images picked up by the respective cameras and obtaining a parallelized first image and a parallelized second image by rectifying the first image and the second image so that epipolar lines of the first image and the second image are parallelized;
acquiring three-dimensional position of respective pixels in the parallelized first image on the basis of a correspondence relation indicating pixels in the parallelized second image to which the respective pixels in the parallelized first image correspond;
detecting the position to display the window in a display area on the display;
rotating the three-dimensional position at the respective pixels on the basis of the position of display of the window and determining the amount of rotation for viewpoint conversion for obtaining a virtual viewpoint image picked up from a virtual viewpoint which is the center of the window to be displayed;
generating the virtual viewpoint image from the three-dimensional position of the respective pixels and the amount of rotation; and
outputting the virtual viewpoint image.
